(19) United States
(12) Patent Application Publication
(10) Pub. No.: US 2014/0071511 A1
(43) Pub. Date: Mar. 13, 2014

(54) WAVELENGTH SELECTIVE SWITCH

(71) Applicant: Sumitomo Electric Industries, Ltd., Osaka-shi (JP)

(72) Inventors: Masaki SUZUKI, Yokohama-shi (JP); Hidehisa TAZAWA, Yokohama-shi (JP); Tomohiko KANIE, Yokohama-shi (JP); Hiroo KANAMORI, Yokohama-shi (JP)

(73) Assignee: Sumitomo Electric Industries, Ltd., Osaka-shi (JP)

(21) Appl. No.: 14/025,467

(22) Filed: Sep. 12, 2013

(30) Foreign Application Priority Data
Sep. 13, 2012 (JP) 2012-202002

(51) Int. Cl. G02B 26/08

(52) U.S. Cl. CPC G02B 26/0833
USPC 359/223.1

(57) ABSTRACT

In a wavelength selective switch, respective values are set to satisfy an expression (θ₂>2×θ₁+α). Therefore, when an inclination angle of a mirror is changed to move primary reflected light to be close to an output port in operation, secondary reflected light moves away from the output port. Therefore, when an inclination angle of a mirror is changed to couple the primary reflected light to the output port, coupling of the secondary reflected light to the output port is suppressed.

### TECHNICAL FIELD

The present invention relates to a wavelength selective switch that disperses wavelength-multiplexed light from an input port and outputs dispersed light from an output port.

### BACKGROUND

For example, a wavelength selective switch described in Japanese Patent No. 4651635 (Patent Document 1) is known as related art in the above technical field. The wavelength selective switch described in Patent Document 1 includes an input port and an output port arranged in a first direction, a diffraction grating as a dispersive element which disperses light output from the input port according to wavelengths and angle-disperses the light in a second direction orthogonal to the first direction, a condensing lens which condenses the light of each wavelength angle-dispersed by the dispersive element, and a mirror array having a plurality of mirrors arranged in a condensing position of the light of each wavelength condensed by the condensing lens. The related art in the technical field is also described in Japanese Patent Application Laid-Open No. 2011-2779 (Patent Document 2) and Japanese Patent Application Laid-Open No. 2007-163780 (Patent Document 3).

### SUMMARY

Incidentally, in a wavelength selective switch, it is desirable for reflected light from a mirror (primary reflected light) not to be coupled to an output port when the mirror array is in a non-operating state. In the wavelength selective switch described in Patent Document 1, a condensing lens is shifted in the second direction to divert the primary reflected light in the second direction and suppress coupling of the primary reflected light to the output port when the mirror array is in the non-operating state. However, if the condensing lens is shifted in this way, parts such as the mirror array should be mounted according to a shift amount of the condensing lens, thereby making a process complex and alignment difficult.

On the other hand, as in the wavelength selective switch described in Patent Document 2, when the mirror array is in the non-operating state, if the mirror is inclined with respect to a dispersive direction of a dispersive element, the primary reflected light is diverted from the output port without a shift of the condensing lens, thereby coupling of the primary reflected light to the output port is suppressed. However, if the mirror is inclined with respect to the dispersive direction of the dispersive element, distances from the condensing lens to the mirror become different in accordance with respective wavelengths.

Therefore, diverting the primary reflected light from the output port by inclining the mirror array in a direction orthogonal to the dispersive direction of the dispersive element may be considered in order to prevent the primary reflected light from being coupled to the output port when the mirror array is in the non-operating state. In this case, it can be avoided that the distances from the condensing lens to the mirror is different in accordance with wavelengths. However, in this case, when a cover is provided for the mirror as described in Patent Document 3, a problem which will be described next is generated. This problem will be described in detail.

FIG. 6 is a diagram illustrating an example of the wavelength selective switch. As illustrated in FIG. 6A, when the mirror array is in the non-operating state, a mirror 6 is inclined with respect to a base line BL which is in parallel with an arrangement direction of an input port 5a and output ports 5b (a direction orthogonal to a dispersive direction of a dispersive element 3) so that reflected light L6 from the mirror 6 (primary reflected light) is diverted from the output port 5b, a secondary reflected light L8 reflected by a cover 7, again reflected by the mirror 6 and then emitted, in addition to the reflected light L7 from the cover 7 (cover reflected light), is also diverted in the same direction as the primary reflected light L6.

In this state, when the mirror array is in an operating state, if an inclination angle of the mirror 6 is changed to move the primary reflected light L6 to approach the output ports 5b as illustrated in FIG. 6B so that the primary reflected light L6 is coupled to the output ports 5b, the cover reflected light L7 is not moved but the secondary reflected light L8 is also moved to approach the output port 5b. As a result, the secondary reflected light L8 may also be coupled to the output port 5b.

One aspect of the present invention relates to a wavelength selective switch. This wavelength selective switch includes an input/output port array in which an input port and an output port are arranged in a first direction; a dispersive element which receives wavelength-multiplexed light from the input port, disperses the wavelength-multiplexed light in a second direction orthogonal to the first direction for each predetermined wavelength component, and emits dispersed light; a condensing optical system which condenses the dispersed light emitted from the dispersive element; and a reflection type deflecting element which receives the dispersed light condensed by the condensing optical system and deflects the dispersed light toward the output port, wherein the reflection type deflecting element includes a deflecting face which receives the dispersed light condensed by the condensing optical system and deflects the dispersed light to the output port, and a cover which covers the deflecting face, the deflecting face is inclined with respect to the first direction when the reflection type deflecting element is in a non-operating state, and an inclination angle θ₁ of the deflecting face with respect to the first direction when the reflection type deflecting element is in the non-operating state, an inclination angle θ₂ of the cover with respect to the first direction, and an inclination angle α to the first direction of the dispersed light incident on the deflecting face satisfy Expression (1) below:

θ₂>2×θ₁+α (1)

In this wavelength selective switch, the deflecting face of the reflection type deflecting element is inclined with respect to an arrangement direction (the first direction) of the input/output ports orthogonal to the dispersive direction (the second direction) of the dispersive element when the reflection type deflecting element is in the non-operating state. Therefore, it is possible to prevent the primary reflected light from the deflecting face from being coupled to the output port when the reflection type deflecting element is in the non-operating state, while suppressing the distance up to the deflecting face from being different in accordance with respective wavelengths. Particularly, the inclination angle θ₁ of the deflecting face with respect to the first direction when the reflection type deflecting element is in the non-operating state, the inclination angle θ₂ of the cover with respect to the first direction, and the inclination angle α to the first direction of the dispersed light incident on the deflecting face satisfy Expression (1) above. Thus, the primary reflected light and the cover reflected light, and the secondary reflected light reflected by the cover, again reflected by the deflecting face and emitted from the reflection type deflecting element are directed to mutually opposing sides with respect to the dispersed light incident on the deflecting face. Therefore, when the reflection type deflecting element is in an operating state, and the inclination angle of the deflecting face is changed to move the primary reflected light to be close to the output port, the secondary reflected light can be moved to be away from the output port. Accordingly, when the inclination of the deflecting face is changed to couple the primary reflected light to the output port, it is possible to suppress coupling of the secondary reflected light to the output port.

In the wavelength selective switch according to an aspect of the present invention, the inclination angle of the deflecting face with respect to the first direction when the reflection type deflecting element is in the operating state may be smaller than the inclination angle θ₁. If the inclination angle of the deflecting face with respect to the first direction is greatest when the reflection type deflecting element is in the non-operating state in this way, Expression (1) above is reliably satisfied even when the inclination angle of the deflecting face is changed when the reflection type deflecting element is in the operating state.

In the wavelength selective switch according to an aspect of the present invention, the inclination angle θ₁, a focal length f of the condensing optical system, a distance L from the input port to the output port most apart from the input port, and the inclination angle α may satisfy Equation (2) below:

L<f×tan(2×(θ₁+α)) (2)

In this case, it is possible to reliably prevent the primary reflected light from being coupled to the output port by sufficiently diverting the primary reflected light from the output port when the reflection type deflecting element is in the non-operating state.

In the wavelength selective switch according to an aspect of the present invention, the inclination angle θ₂, the focal length f of the condensing optical system, the distance L from the input port to the output port most apart from the input port, and the inclination angle α may satisfy Equation (3) below:

L<f×tan(2×(θ₂+α)) (3)

In this case, it is possible to reliably prevent the cover reflected light from being coupled to the output port by sufficiently diverting the cover reflected light from the output port.

In the wavelength selective switch according to an aspect of the present invention, the focal length f of the condensing optical system, the distance L from the input port to the output port most apart from the input port, and an emission angle φ of the secondary reflected light which is reflected by the cover, reflected by the deflecting face again and then emitted from the reflection type deflecting element may satisfy Expression (4) below:

L<f×tan φ (4)

In this case, it is possible to reliably prevent the secondary reflected light from being coupled to the output port by sufficiently diverting the second reflected light from the output port.

In the wavelength selective switch according to an aspect of the present invention, the wavelength selective switch may further include a base having a main surface orthogonal to the first direction, wherein the input/output port array, the dispersive element and the condensing optical system are mounted on the main surface of the base, and the cover of the reflection type deflecting element may be inclined with respect to the first direction so that the cover reflected light which is condensed by the condensing optical system and then reflected by the cover, is directed to the main surface side of the base. Thus, it is preferable for the cover reflected light which is not influenced by a change of the inclination angle of the deflecting face to be directed to the base side, rather than the secondary reflected light moving with the change of the inclination angle of the deflecting face.

In the wavelength selective switch according to an aspect of the present invention, a position hit by the cover reflected light on the main surface of the base may be subjected to rough surface processing or optical absorption processing. In this case, it is possible to prevent the cover reflected light from being reflected in the position and becoming stray light.

In the wavelength selective switch according to an aspect of the present invention, a fiber for transmitting monitoring-light may be provided in a position hit by the cover reflected light on the main surface of the base. In this case, it is possible to monitor light output with high precision using the cover reflected light arriving at a certain position without depending on the inclination angle of the deflecting face. Further, since the secondary reflected light is diverted to a side opposite to the cover reflected light, it is possible to prevent the secondary reflected light from being coupled to the fiber for transmitting the monitoring-light.

In the wavelength selective switch according to an aspect of the present invention, the input port may be arranged in a center of the input/output port array with respect to the first direction. In this case, it is possible to simplify an optical design and relatively reduce loss.

### BRIEF DESCRIPTION OF THE DRAWINGS

FIG. 1 is a side view illustrating a schematic configuration of a wavelength selective switch when a reflection type deflecting element is in a non-operating state according to a first embodiment;

FIG. 2 is a plan view illustrating the schematic configuration of the wavelength selective switch illustrated in FIG. 1;

FIG. 3 is a main enlarged side view of a mirror and a cover illustrated in FIG. 1;

FIG. 4 is a side view illustrating a schematic configuration of the wavelength selective switch when a reflection type deflecting element is in an operating state according to the first embodiment;

FIG. 5 is a side view illustrating a schematic configuration of a variant of the wavelength selective switch shown in FIGS. 1 and 4;

FIGS. 6A and 6B are side views illustrating a schematic configuration of an example of the wavelength selective switch;

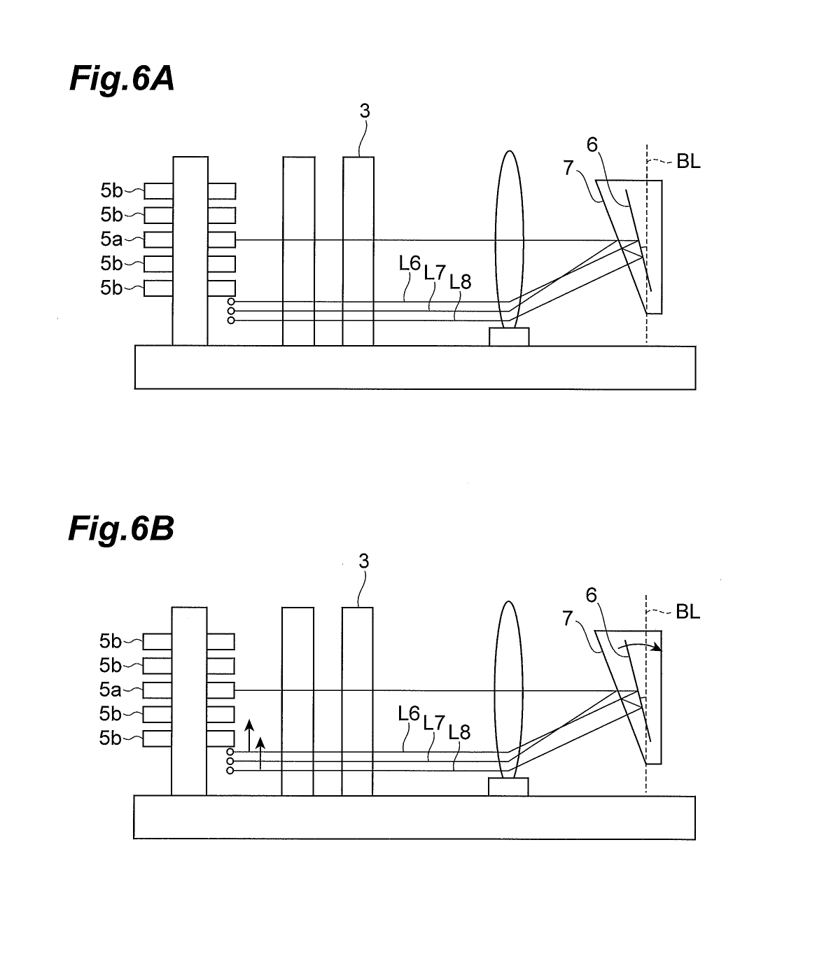

FIG. 7 is a side view illustrating a schematic configuration of a wavelength selective switch according to a second embodiment;

FIG. 8 is a plan view illustrating the schematic configuration of the wavelength selective switch illustrated in FIG. 7;

FIG. 9 is a main enlarged plan view of the wavelength selective switch illustrated in FIG. 7;

FIGS. 10A and 10B are graphs illustrating a change in intensity of light to be coupled to an output port;

FIGS. 11A to 11D are schematic views illustrating an example of an operation of a control unit at the time of port switching;

FIGS. 12A and 12B are schematic views illustrating another example of the operation of the control unit at the time of port switching;

FIG. 13 is a side view illustrating a schematic configuration of a variant of the wavelength selective switch illustrated in FIG. 7; and

FIG. 14 is a cross-sectional view illustrating an LCOS as an example of a phase modulation element.

### DETAILED DESCRIPTION

Hereinafter, an embodiment of a wavelength selective switch will be described with reference to the accompanying drawings. Further, in the following description of the drawings, the same elements or equivalent elements are denoted by the same reference signs and a repeated description is omitted.

### First Embodiment

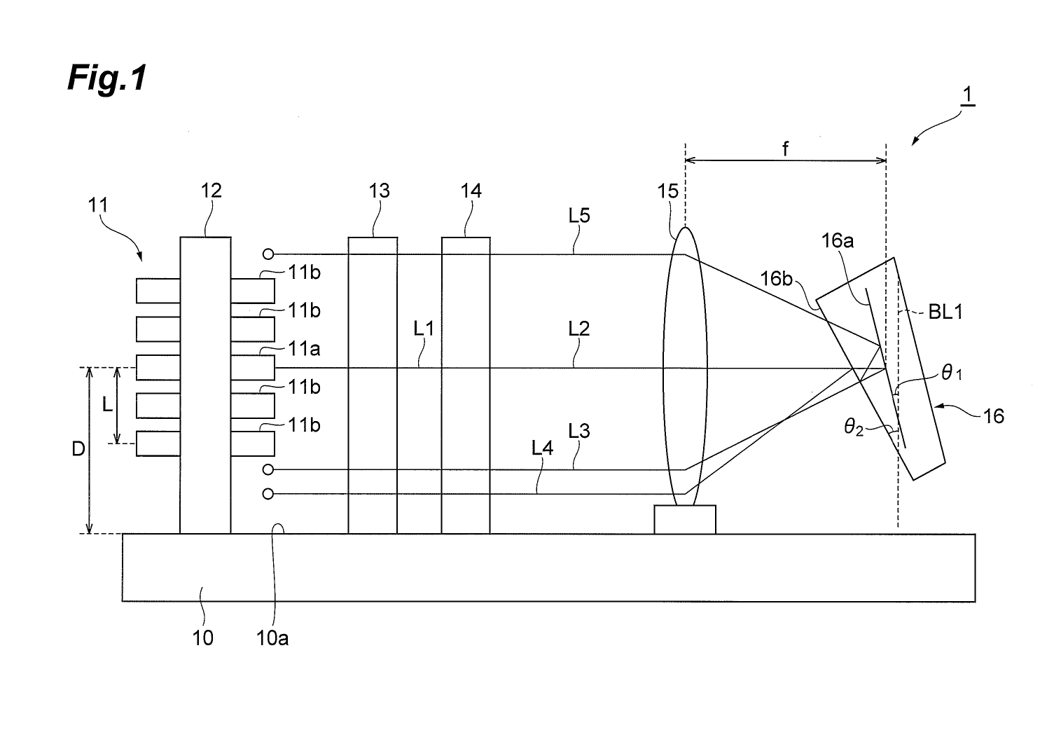

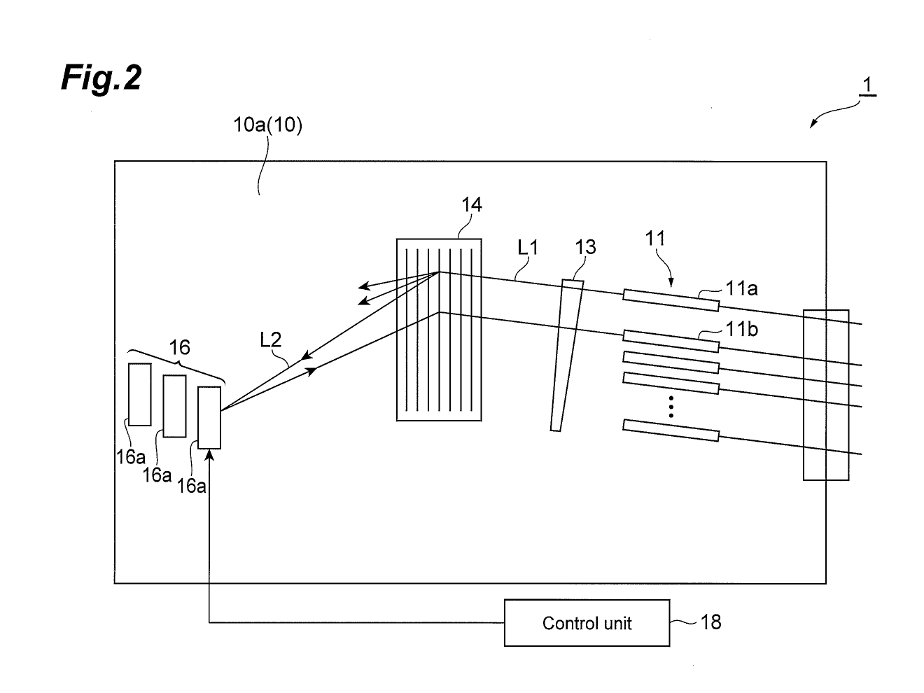

FIG. 1 is a side view illustrating a schematic configuration of a wavelength selective switch according to a first embodiment. FIG. 2 is a plan view illustrating the schematic configuration of the wavelength selective switch illustrated in FIG. 1. A wavelength selective switch 1 includes a base 10, an input/output port array 11, a collimator 12, an anamorphic optical system 13, a diffraction grating (a dispersive element) 14, a condensing optical system 15, an MEMS (Micro Electro Mechanical System) mirror (a reflection type deflecting element) 16, and a control unit 18, as illustrated in FIG. 1 or 2.

The base 10 has a main surface 10a. The input/output port array 11, the collimator 12, the anamorphic optical system 13, the diffraction grating 14 and the condensing optical system 15 are mounted on the main surface 10a of the base 10. The input/output port array 11 includes an input port 11a for inputting light, and output ports 11b for outputting light. Here, the input/output port array 11 is configured by arranging one input port 11a and a plurality of output ports 11b in a direction (a first direction) orthogonal to the main surface 10a of the base 10. The input port 11a is arranged in a center of the input/output port array 11 with respect to the direction orthogonal to the main surface 10a of the base 10.

The anamorphic optical system 13 expands a beam diameter of the light from the input/output port array 11. An expanding direction of the beam diameter in the anamorphic optical system 13 is a direction (a second direction) orthogonal to the arrangement direction of the input port 11a and the output ports 11b. The anamorphic optical system 13 includes, for example, a prism. The diffraction grating 14 disperses light from the anamorphic optical system 13 for each predetermined wavelength component and emits dispersed lights. The dispersive direction of the diffraction grating 14 is a direction (the second direction) orthogonal to the arrangement direction of the input port 11a and the output ports 11b. The condensing optical system 15 condenses respective dispersed lights from the diffraction grating 14.

The MEMS mirror 16 receives the dispersed lights condensed by the condensing optical system 15 and deflects the dispersed lights toward the different output ports 11b in accordance with their respective wavelength components. The MEMS mirror 16 includes a plurality of mirrors (deflecting faces) 16a arranged in a focal position of the condensing optical system 15 to reflect (deflect) the dispersed lights condensed by the condensing optical system 15 to the output ports 11b, and a cover 16b which covers the mirrors 16a. The mirrors 16a are provided to correspond to a plurality of the dispersed lights of a respective wavelengths components and each mirror can independently switch an optical path.

The MEMS mirror 16 is electrically connected to the control unit 18 and driven. Therefore, in the wavelength selective switch 1, an inclination angle of the mirror 16a of the MEMS mirror 16 can be controlled to be a desired angle by the control unit 18. Further, the MEMS mirror 16 may be mounted on the main surface 10a of the base 10 or may be mounted on any of other members.

In such a wavelength selective switch 1, first, wavelength-multiplexed light is input from the input port 11a. The beam diameter of the wavelength-multiplexed light input from the input port 11a is expanded by the anamorphic optical system 13. The wavelength-multiplexed light L1 whose beam diameter has been expanded by the anamorphic optical system 13 is dispersed by the diffraction grating 14 for each predetermined wavelength component. The optical paths of the dispersed lights L2 dispersed by the diffraction grating 14 are adjusted by a turning mirror which is not illustrated. Further, the dispersed light is guided to the predetermined mirror 16a of the MEMS mirror 16 by the condensing optical system 15 and then reflected by the mirror 16a. Also, the dispersed light proceeds in the above-described path in a reverse direction, and is output from the output port 11b.

Here, when the MEMS mirror 16 is in a non-operating state, as illustrated in FIG. 1, the mirror 16a of the MEMS mirror 16 is inclined at an inclination angle θ₁ with respect to a base line BL1 which is in parallel with the arrangement direction of the input port 11a and the output ports 11b. Further, a cover (a surface of the cover 16b facing the mirror 16a) 16b is inclined at an inclination angle θ₂ with respect to the base line BL 1.

This is intended to divert the reflected light L3 from the mirror 16a (the primary reflected light which is first reflected by the mirror 16a) from the output port 11b, and to divert the reflected light (the cover reflected light) L4 from the cover 16b from the output port 11b, when the MEMS mirror 16 is in the non-operating state. Therefore, when the MEMS mirror 16 in an operating state, the inclination angle of the mirror 16a with respect to the base line BL 1 is changed (reduced) and the primary reflected light L3 is coupled to the output port 11b.

In this case, light L5, which is multiply reflected between the mirror 16a and an inner surface of the cover 16b and then emitted from the MEMS mirror 16 (from the cover 16b) (here, the secondary reflected light which is first reflected by the mirror 16a, reflected by the cover 16b, reflected by the mirror 16a again and then emitted from the MEMS mirror 16 among multiple-reflected lights), is not coupled to the output port 11b. Therefore, when the MEMS mirror 16 is in the non-operating state, the inclination angle θ₁ of the mirror 16a and the inclination angle θ₂ of the cover 16b are set to satisfy a predetermined condition. This predetermined condition will be described in detail. Further, a base (a surface opposite to the mirror 16a) of the cover 16b is substantially parallel with the mirror 16a, when the MEMS mirror 16 is in the non-operating state.

When the MEMS mirror 16 is in the operating state, if the inclination angle of the mirror 16a is reduced to couple the primary reflected light L3 to the output port 11b, the primary reflected light L3 approaches the output port 11b along the base line BL1. At this time, if the secondary reflected light L5 is moved to be away from the output port 11b along the base line BL1, the secondary reflected light L5 is prevented from being coupled to the output port 11b. Therefore, when MEMS mirror 16 is in the operating state, it is necessary to cause the primary reflected light L3 and the cover reflected light L4, and the secondary reflected light L5 to be directed in mutually opposing directions with respect to the dispersed light L2 incident on the mirror 16a (to be away from each other).

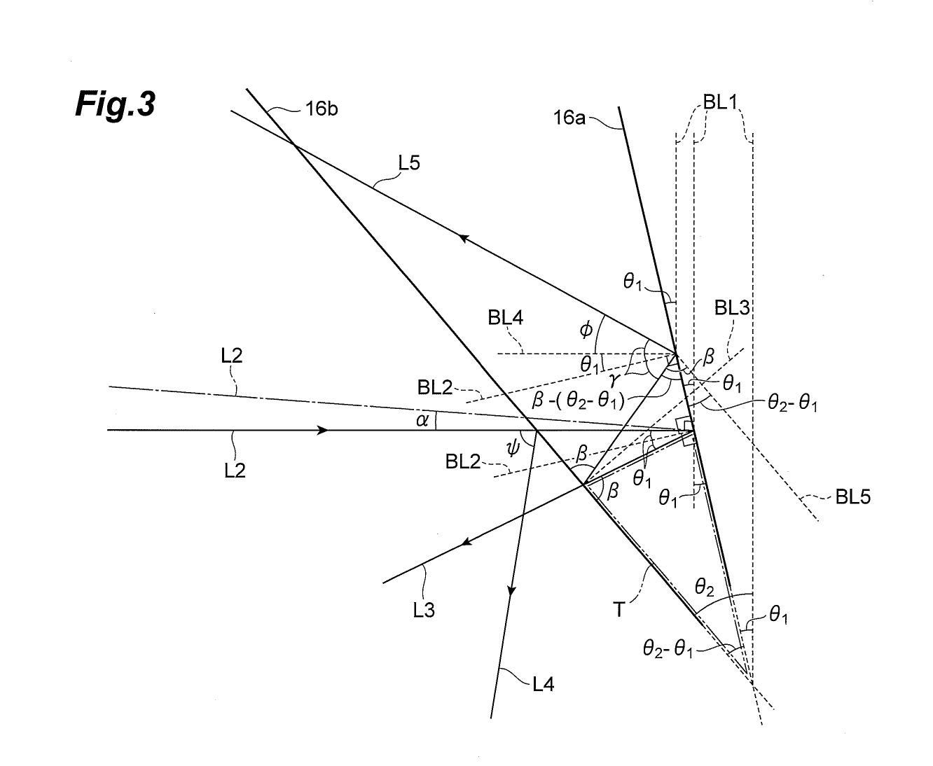

Here, as shown in FIGS. 1 and 3, the primary reflected light L3 and the cover reflected light L4 are directed to a lower side (the side of the main surface 10a of the base 10) in the arrangement direction of the input port 11a and the output ports 11b (a direction along the base line BL1) with respect to the dispersed light L2 incident on the mirror 16a. Therefore, in this case, the secondary reflected light L5 may be directed to an upper side in the arrangement direction of the input port 11a and the output ports 11b (a surface apart from the main surface 10a of the base 10) with respect to the dispersed light L2. Thus, an angle β formed between the primary reflected light L3 and the cover 16b may be less than 90° to reflect a part of the primary reflected light L3 which becomes the secondary reflected light L5 to the upper side by means of the cover 16b. In other words, the angle β formed between the primary reflected light L3 and the cover 16b may satisfy Expression (A) below:

β<90° (A)

The angle β formed between the primary reflected light L3 and the cover 16b is β=180°−(θ₂−θ₁)−(90°−θ₁) considering a triangle T illustrated in FIG. 3. Accordingly, when Expression (A) above is changed for the inclination angles θ₁ and θ₂, Expression (B) below is obtained:

θ₂>2×θ₁ (B)

In a general case in which the inclination angle α of the dispersed light L2 incident on the mirror 16a to the base line BL1 is greater than 0° (i.e., a case in which the dispersed light L2 is not perpendicular to the base line BL1), Expression (B) above becomes Expression (1) below:

θ₂>2×θ₁+α (1)

In other words, if the inclination angles θ₁ and θ₂ satisfy Expression (1) above, the primary reflected light L3 and the cover reflected light L4, and the secondary reflected light L5 can be directed in mutually opposing directions with respect to the dispersed light L2 incident on the mirror 16a. As a result, when the MEMS mirror 16 is in the operating state, it is possible to suppress coupling of the secondary reflected light L5 to the output port 11b. Further, in FIG. 3, a base line BL2 indicates a normal line of the mirror 16a, a base line BL3 indicates a normal line of the cover 16b, and a base line BL4 indicates a line parallel with an optical axis of the dispersed light L2 incident on the mirror 16a (a line perpendicular to the dispersive direction of the diffraction grating 14 and the base line BL1 herein).

Further, as the inclination angle of the mirror 16a with respect to the base line BL1 in the operating state of the MEMS mirror 16 is smaller than the inclination angle θ₁, in other words, as the inclination angle of the mirror 16a with respect to the base line BL1 is greatest in the non-operating state, Expression (1) above can be reliably satisfied even when the inclination angle of the mirror 16a is changed when the MEMS mirror 16 is in the operating state.

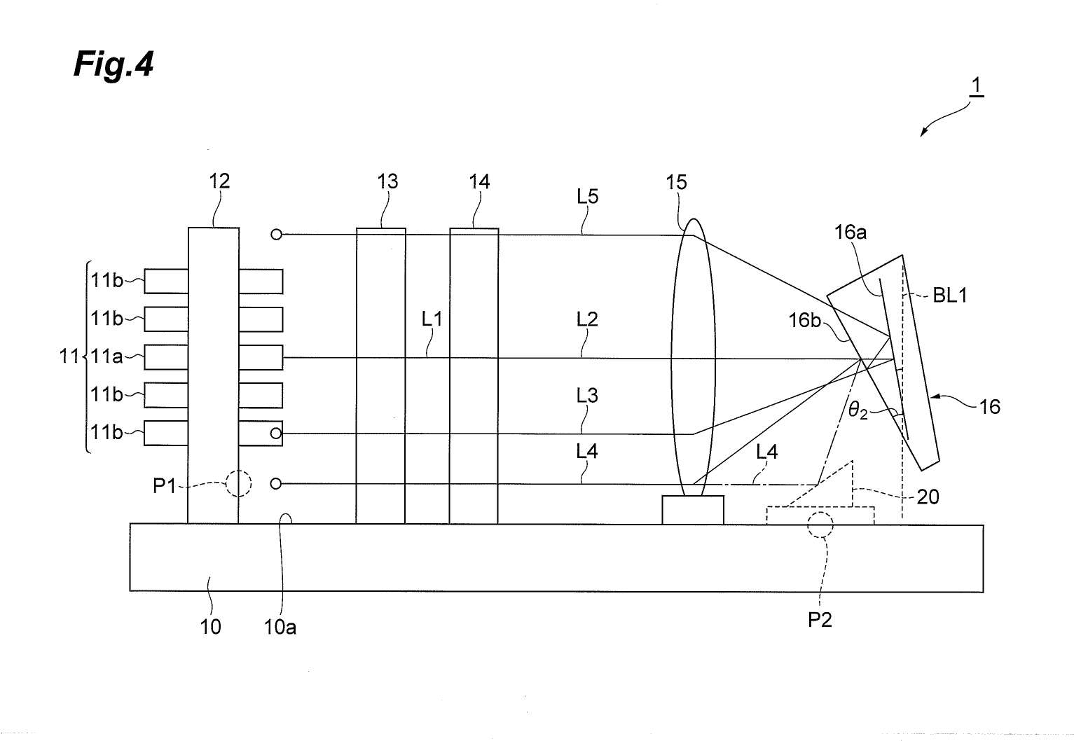

Thus, in the wavelength selective switch 1 according to the present embodiment, the respective values are set to satisfy Expression (1) above, and therefore, when the inclination angle of the mirror 16a is changed to move the primary reflected light L3 along the base line BL1 to be close to the output port 11b in the operating state of the MEMS mirror 16, the secondary reflected light L5 is moved away from the output port 11b along the base line BL1. Thus, as illustrated in FIG. 4, when the inclination angle of the mirror 16a is changed to couple the primary reflected light L3 to the output port 11b, coupling of the secondary reflected light L5 to the output port 11b is suppressed. Further, such an effect is not limited to the case of the secondary reflected light and can also be obtained for multiple-reflected light, which is multiply reflected between the mirror 16a and the cover 16b and then emitted from the MEMS mirror 16. Further, in the present embodiment, a distance between the mirror 16a and the cover 16b is ignored since the distance is much smaller than the focal length f.

Here, the wavelength selective switch 1 according to the present embodiment satisfies the following condition in order to reliably prevent the primary reflected light L3, the cover reflected light L4 and the secondary reflected light L5 from being coupled to the output port 11b when the MEMS mirror 16 is in the non-operating state.

In other words, as illustrated in FIG. 1, in order to divert the primary reflected light L3 from the output port 11b when the MEMS mirror 16 is in the non-operating state, the inclination angle θ₁, the focal length f of the condensing optical system 15, the distance L from the input port 11a to the output port 11b most apart (farthest) from the input port 11a, and the inclination angle α (0° in FIG. 1) satisfy Expression (2) below:

L<f×tan(2×(θ₁+α)) (2)

For example, when the distance L=6 mm, the focal length f=100 mm and the inclination angle α=0° as examples of the respective values and if the inclination angle θ₁=2.2°, Expression (2) above is satisfied as shown in:

6<100×tan(2×(2.2°+0°))≈7.69

Further, in order to divert the cover reflected light L4 from the output port 11b, the inclination angle θ₂, the focal length f, the distance L and the inclination angle α satisfy Expression (3) below:

L<f×tan(2×(θ₂+α)) (3)

For example, when the distance L=6 mm, the focal length f=100 mm and the inclination angle α=0° as examples of the respective values and if the inclination angle θ₂=4.5°, Expression (3) above is satisfied as shown in:

6<100×tan(2×(4.5°+0°))≈15.84

Further, in order to divert the secondary reflected light L5 from the output port 11b, the focal length f, the distance L and the emission angle φ of the secondary reflected light L5 satisfy Equation (4) below:

L<f×tan φ (4)

Here, as illustrated in FIG. 3, when the inclination angle α=0°, the emission angle φ of the secondary reflected light L5 is equal to γ−θ₁=2×(θ₂−θ₁). γ is equal to 90°−(θ₂−θ₁). Accordingly, Expression (4) above is expressed as Expression (C) below:

L<f×tan(2×(θ₂−θ₁)) (C)

When the inclination angle α is not 0°, Expression (C) above is expressed as Expression (D) below:

L<f×tan(2×(θ₂−θ₁)−α) (D)

Further, a base line BL5 indicates a line which is in parallel with the cover 16b.

When the distance L=6 mm, the focal length f=100 mm, and the inclination angle α=0° as examples of the respective values, and if the inclination angle θ₁=2.2° and the inclination angle θ₂=4.5°, Expression (D) above (i.e., Expression (4) above) is satisfied as shown in:

6<100×tan(2×(4.5°−2.2°)−0°)≈8.05.

Here, a removal portion which removes the cover reflected light L4 directed to a side of the main surface 10a of the base 10 may be provided on the main surface 10a of the base 10. For example, as illustrated in FIG. 4, this removal portion may be configured by performing rough surface processing or optical absorption processing on the main surface 10a of the base 10 or the like in positions P1 and P2 hit by the cover reflected light L4. If the removal portion is provided in this way, the cover reflected light L4 can be prevented from being reflected from the positions P1 and P2 and coupled to an unintended output port.

Further, a fiber for transmitting monitoring-light may be provided in the predetermined position P1 of the input/output port array 11 and the collimator 12. In this case, it is possible to monitor light output with high precision using the cover reflected light L4 arriving at a certain position without depending on the inclination angle of the deflecting face. Further, since the secondary reflected light L5 is diverted toward a side opposite to the cover reflected light L4, it is possible to prevent the secondary reflected light L5 from being coupled to the fiber for transmitting monitoring-light.

Further, when a reflection angle of the cover reflected light L4 from the cover 16b is great, an optical path changing mirror 20 may be provided in the position P2 so that the cover reflected light L4 can be guided to the fiber for transmitting monitoring-light which is provided in the position P1 as described above.

Thus, in the wavelength selective switch 1 according to the present embodiment, since the respective values further satisfy Expressions (2) to (4) above, the primary reflected light L3, the cover reflected light L4 and the secondary reflected light L5 are diverted sufficiently from the output port 11b when the MEMS mirror 16 is in the non-operating state, thereby reliably preventing the lights from being coupled to the output port. Further, it is possible to suppress the cover reflected light L4 directed to the main surface 10a of the base 10 or the like hitting the main surface 10a and then being coupled to an unintended output port.

In the above embodiment, the embodiment of the wavelength selective switch according to one aspect of the present invention has been described. Accordingly, the wavelength selective switch according to the present invention is not limited to the wavelength selective switch 1 described above. For the wavelength selective switch according to the present invention, the wavelength selective switch 1 described above may be arbitrarily changed without departing from the gist of each claim.

In the above embodiment, while the case in which the primary reflected light L3 and the cover reflected light L4 are directed to the side of the main surface 10a of the base 10, and the secondary reflected light L5 is directed to the side opposite to the main surface 10a has been described, a progressing direction of each light may be reversed. In this case, in order for the secondary reflected light L5 not to hit the main surface 10a of the base 10, the respective values may satisfy Equation (5) below:

L<f×tan(2×(θ₂−θ₁)−α)<D (5)

When the distance L=6 mm, the focal length f=100 mm, the inclination angle α=0° and the distance D=7.5 mm as examples of the respective values and if the inclination angle θ₁=2.2° and the inclination angle θ₂=4.3°, Expression (6) above is satisfied as shown in:

6<100×tan(2×(4.3°−2.2°)−0°)≈7.34<7.5

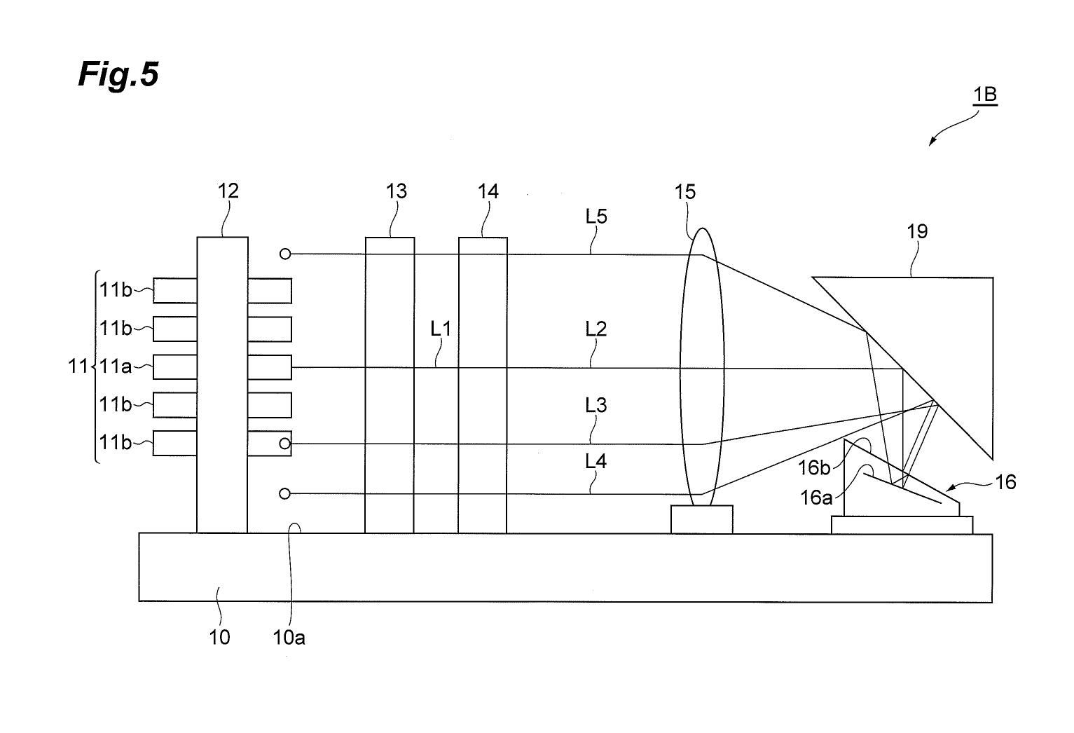

Further, for example, as illustrated in FIG. 5, the present invention may be applied to a wavelength selective switch 1B in which dispersed light L2 condensed by the condensing optical system 15 is changed by 90° in direction by a turning mirror 19 and then incident on an MEMS mirror 16.

### Second Embodiment

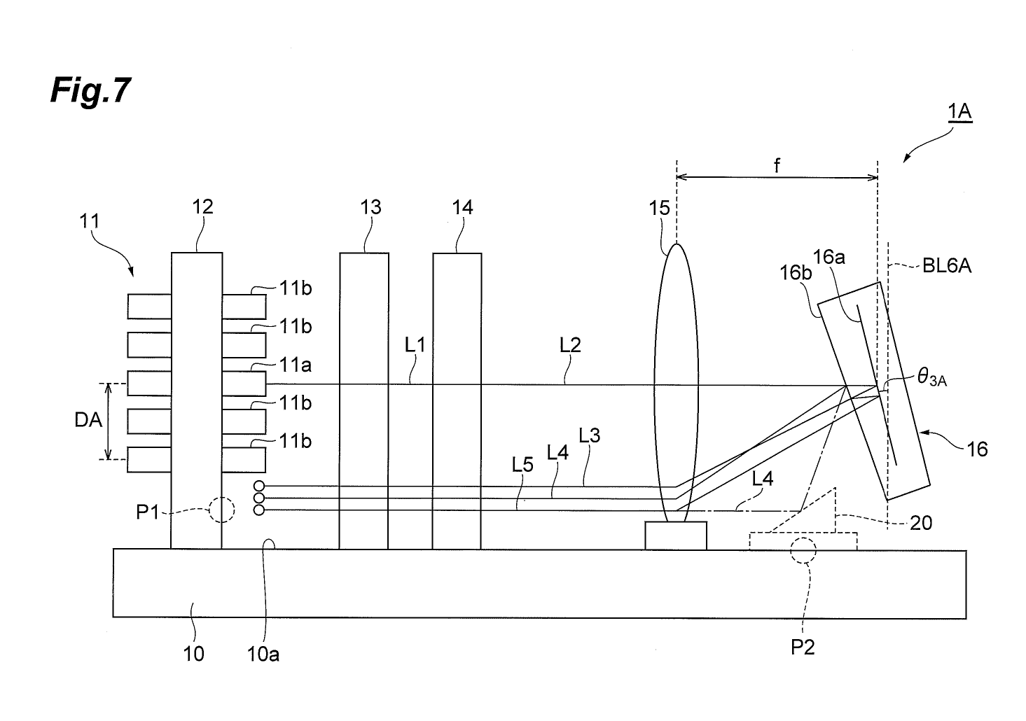

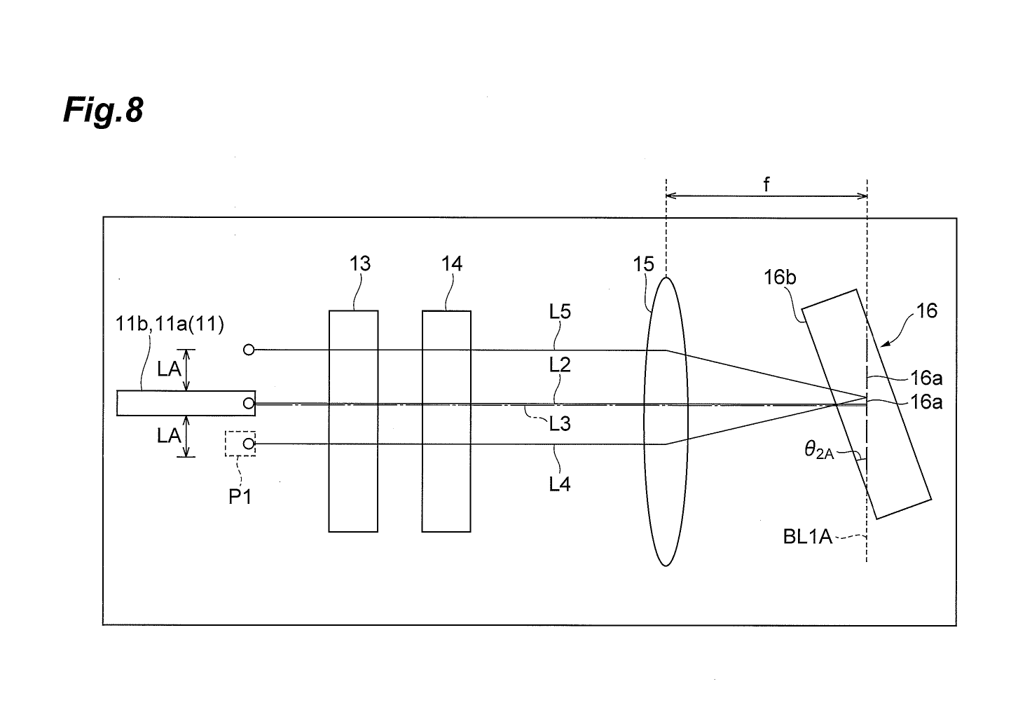

FIG. 7 is a side view illustrating a schematic configuration of a wavelength selective switch according to a second embodiment. FIG. 8 is a plan view illustrating the schematic configuration of the wavelength selective switch illustrated in FIG. 7. As illustrated in FIGS. 7 and 8, the wavelength selective switch 1A according to the present embodiment has a configuration similar to the wavelength selective switch 1 described above. Here, as illustrated in FIG. 8, a cover 16b of an MEMS mirror 16 is inclined with respect to a base line BL1A which is in parallel with a direction orthogonal to an arrangement direction of an input port 11a and output ports 11b (i.e., a dispersive direction of a diffraction grating 14). Inclination of the cover 16b with respect to the base line BL1A is set so that cover reflected light L4 which is condensed by a condensing optical system 15 and reflected by the cover 16b, and light L5 which is condensed by the condensing optical system 15, multiply reflected between the mirror 16a and an inner surface of the cover 16b, and then emitted from the MEMS mirror 16 (from the cover 16b) (here, secondary reflected light which is first reflected by the mirror 16a, reflected by the cover 16b, reflected by the mirror 16a again, and then emitted from the MEMS mirror 16 among multiple-reflected lights) are diverted from the output port 11b with respect to the dispersive direction of the diffraction grating 14.

More specifically, in order to divert the cover reflected light L4 from the output port 11b, when a focal length of the condensing optical system 15 is f, an inclination angle of dispersed light L2 incident on the MEMS mirror 16 to the base line BL1A is α_{2A} (0° in FIG. 8), a distance from the output port 11b for reducing intensity of light to be coupled to the output port 11b by about 40 dB is LA, and an enlargement magnification of an anamorphic optical system 13 is r, an inclination angle θ_{2A} of the cover 16b with respect to the base line BL1A in the dispersive direction of the diffraction grating 14 satisfies Expression (2A) below:

LA<(1/r)×f×tan(2×(θ_{2A}+α_{2A})) (2A)

Accordingly, the cover reflected light L4 is sufficiently diverted from the output port 11b and coupling of the cover reflected light L4 to the output port 11b is suppressed.

If the distance LA=1 mm, the focal length f=100 mm, the inclination angle α_{2A}=0°, the enlargement magnification r=10, and the inclination angle θ_{2A}=3.5° as examples of the respective values, Expression (2A) above is satisfied as shown in:

1<( 1/10)×100×tan(2×(3.5°+0°))≈1.23

Further, in the wavelength selective switch 1A, in order to divert the secondary reflected light L5 from the output port 11b, an emission angle φ_{A} of the secondary reflected light L5, the distance LA, the focal length f and the enlargement magnification r satisfy Expression (4A) below:

LA<(1/r)×f×tan φ_{A} (4A)

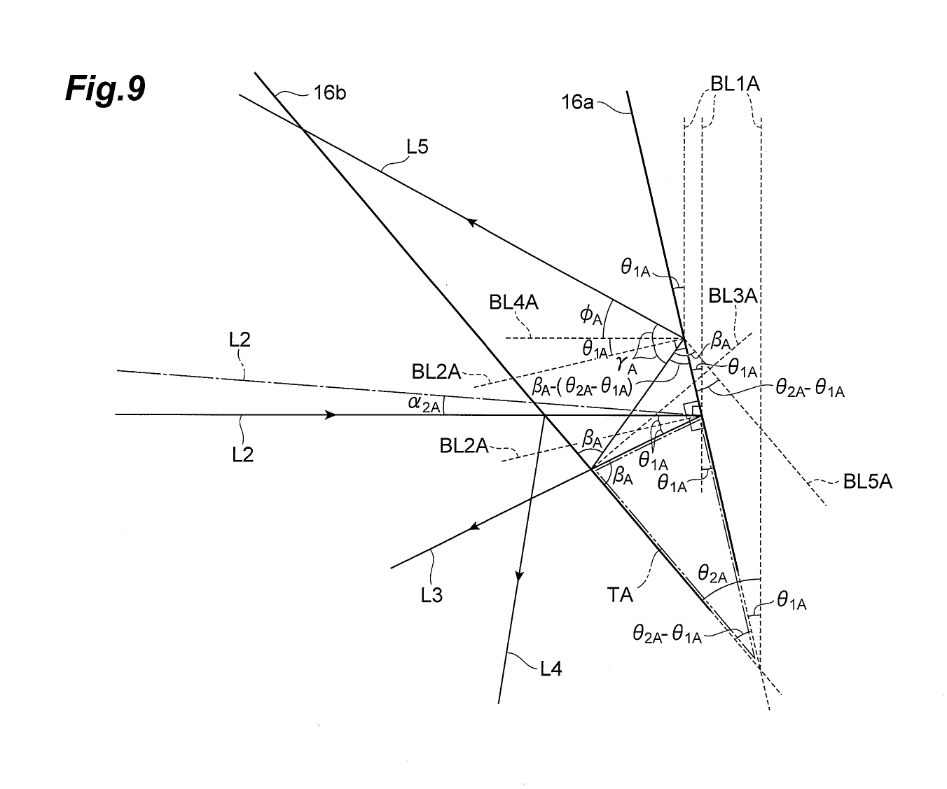

Here, if the inclination angle of the mirror 16a with respect to the base line BL1A in the dispersive direction of the diffraction grating 14 is θ_{1A} (0° in FIG. 8) and when the inclination angle α_{2A}=0°, as illustrated in FIG. 9, the emission angle of the secondary reflected light L5 is φ_{A}=γ_{A}−θ_{1A}=2×(θ_{2A}−θ_{1A}) (γ_{A}=90°−(β_{A}−(θ_{2A}−θ_{1A})) and β_{A}=90°−θ_{2A}+2×θ_{1A}), and therefore Expression (4A) above is expressed as Expression (AA) below:

LA<(1/r)×f×tan(2×(θ_{2A}−θ_{1A})) (AA)

When the inclination angle α_{2A} is not 0° as illustrated in FIG. 9, Expression (AA) above becomes Expression (BA) below:

LA<(1/r)×f×tan(2×(θ_{2A}−θ_{1A})−α_{2A}) (BA)

Thus, by satisfying Expression (BA) above (in other words, by satisfying Expression (4A) above), the secondary reflected light L5 is sufficiently diverted from the output port 11b and coupling of the secondary reflected light L5 to the output port 11b is suppressed.

If the distance LA=1 mm, the focal length f=100 mm, the inclination angle θ_{1A}=0°, the inclination angle θ_{2A}=3.5°, the inclination angle α_{2A}=0° and the enlargement magnification r=10 as examples of the respective values, Expression (BA) above is satisfied as shown in:

1<( 1/10)×100×tan(2×(3.5°−0°)−0°)≈1.23

Further, in FIG. 9, a base line BL2A indicates a normal line of the mirror 16a, a base line BL3A indicates a normal line of the cover 16b, and a base line BL4A indicates a line which is in parallel with an optical axis of the dispersed light L2 incident on the mirror 16a (a line perpendicular to the arrangement direction of the input port 11a and the output ports 11b, and to the base line BL1A herein). Further, a base line BL5A indicates a line which is in parallel with the cover 16b. Further, in the present embodiment, a distance between the mirror 16a and the cover 16b is ignored since the distance is much smaller than the focal length f.

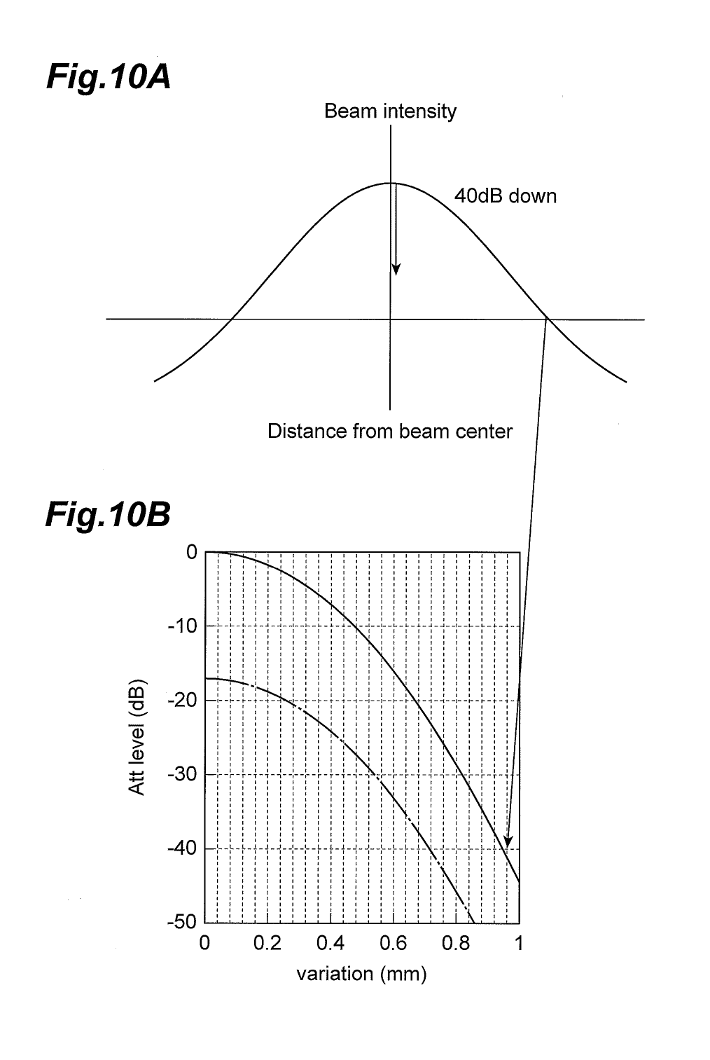

Further, for example, when predetermined light (e.g., the reflected light (first reflected light) L3 from the mirror 16a) has a beam profile as illustrated in FIG. 10A, a detected light intensity decreases as a distance of a center of the beam from the output port 11b increases and, therefore, the distance LA from the output port 11b for reducing intensity of light to be coupled to the output port 11b by about 40 dB in the present embodiment may be about 1 mm, as illustrated in FIG. 10B.

Thus, in the wavelength selective switch 1A according to the present embodiment, the cover 16b is inclined with respect to the base line BL1A so that the cover reflected light L4 and the secondary reflected light L5 are diverted from the output port 11b with respect to the dispersive direction of the diffraction grating 14. Particularly, in the wavelength selective switch 1, since the respective values satisfy Expressions (2A) and (4A) above, the cover reflected light L4 and the secondary reflected light L5 are diverted sufficiently from the output port 11b, and coupling to the output port 11b is reliably suppressed. Further, such an effect is not limited to the case of the secondary reflected light and can also be obtained similarly for the multiply reflected light which is multiply reflected between the mirror 16a and the cover 16b and then emitted from the MEMS mirror 16.

Here, the wavelength selective switch 1A according to the present embodiment also satisfies the following condition. In other words, in the wavelength selective switch 1, as illustrated in FIG. 7, the mirror 16a is inclined with respect to the base line BL6A which is in parallel with the arrangement direction of the input port 11a and the output ports 11b (i.e., a direction orthogonal to the dispersive direction of the diffraction grating 14) when the MEMS mirror 16 is in the non-operating state.

Particularly, an inclination angle θ_{3A} of the mirror 16a with respect to the base line BL6A in the arrangement direction of the input port 11a and the output ports 11b, an inclination angle α₃ of the dispersed light L2 incident on the MEMS mirror 16 to the base line BL6A, a distance DA from the input port 11a to the output port 11b farthest from the input port 11a, and the focal length f satisfy Expression (5A) below:

DA<f×tan(2×(θ_{3A}+α_{3A})) (5A)

Thus, when the MEMS mirror 16 is in the non-operating state, the primary reflected light L3 is diverted from the output port 11b with respect to the arrangement direction of the input/output port array 11 and the output ports 11b, and coupling of the primary reflected light L3 to the output port 11b is suppressed. Further, the base (a surface opposite to the mirror 16a) of the cover 16b is substantially in parallel with the mirror 16a when the MEMS mirror 16 is in the non-operating state.

Further, as illustrated in FIG. 8, the wavelength selective switch 1A according to the present embodiment satisfies the following condition such that the cover reflected light L4 and the secondary reflected light L5 are directed to mutually opposing sides with the dispersed light L2 incident on the MEMS mirror 16 (i.e., the input/output port array 11) interposed therebetween, with respect to the dispersive direction of the diffraction grating 14.

In order for the cover reflected light L4 and the secondary reflected light L5 to be directed to sides opposite to each other with respect to the dispersed light L2 incident on the MEMS mirror 16, as illustrated in FIG. 9, when the cover reflected light L4 is directed to a lower side in the dispersive direction of the diffraction grating 14, an angle β_{A} formed between the primary reflected light L3 and the cover 16b may be less than 90° and a part of the primary reflected light L3 which becomes the secondary reflected light L5 may be reflected to an upper side by the cover 16b. In other words, the angle β_{A} formed between the primary reflected light L3 and the cover 16b may satisfy Expression (CA) below:

β_{A}<90° (CA)

Since the angle β_{A} formed between the primary reflected light L3 and the cover 16b is β_{A}=180°−(θ_{2A}−θ_{1A})−(90°−θ_{1A})=90°−θ_{2A}+2×θ_{1A} in consideration of the triangle TA illustrated in FIG. 9 as described above, if Expression (CA) above is changed for inclination angles θ_{1A} and θ_{2A}, Expression (DA) below is obtained:

θ_{2A}>2×θ_{1A} (DA)

In a general case in which the inclination angle α_{2A} to the base line BL1A of the dispersed light L2 incident on the mirror 16a is greater than 0° (i.e., a case in which the dispersed light L2 is not perpendicular to the base line BL1A), Expression (DA) above becomes Expression (6A) below:

θ_{2A}>2×θ_{1A}+α_{2A} (6A)

In other words, if the inclination angles θ_{1A} and θ_{2A} satisfy Expression (6A) above, the cover reflected light L4 and the secondary reflected light L5 can be directed in mutually opposite directions with respect to the input/output port array 11. Therefore, for example, when monitoring of the light output is performed using the cover reflected light L4, the secondary reflected light L5 is prevented from being coupled to the fiber for transmitting monitoring-light. Accordingly, it is possible to perform monitoring with high precision.

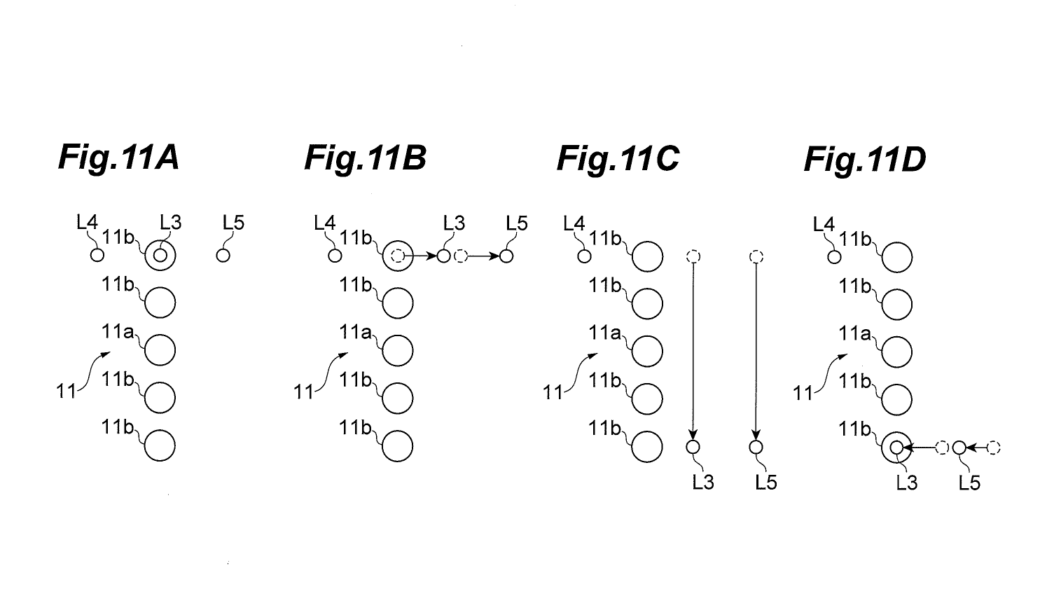

Next, an example of an operation of the control unit 18 in the wavelength selective switch 1A configured as above will be described. FIGS. 11A to 11D are schematic views illustrating an example of an operation of the control unit at the time of port switching, and illustrates a state when the input/output ports are viewed from a front. As illustrated in FIGS. 11A and 11B, at the time of port switching, the control unit 18 first changes the inclination angle of the mirror 16a with respect to a direction orthogonal to the arrangement direction of the input port 11a and the output ports 11b.

Accordingly, the primary reflected light L3 is moved with respect to the direction orthogonal to the arrangement direction of the input port 11a and the output ports 11b, and is diverted from the output port 11b. In this case, the control unit 18 changes the inclination angle of the mirror 16a so that the primary reflected light L3 is moved toward the secondary reflected light L5. Accordingly, since the secondary reflected light L5 is moved away from the output port 11b when the primary reflected light L3 is moved, coupling of the secondary reflected light L5 to the output port 11b can be suppressed.

Then, as illustrated in FIGS. 11B and 11C, the control unit 18 changes the inclination angle of the mirror 16a with respect to the arrangement direction of the input port 11a and the output ports 11b. Accordingly, the primary reflected light L3 is moved with respect to the arrangement direction of the input port 11a and the output ports 11b. In this case, the control unit 18 controls the inclination angle of the mirror 16a so that the primary reflected light L3 is moved to a position corresponding to the desired output port 11b.

Also, as illustrated in FIGS. 11C and 11D, the control unit 18 changes the inclination angle of the mirror 16a with respect to the direction orthogonal to the arrangement direction of the input port 11a and the output ports 11b. Here, the inclination angle of the mirror 16a returns to an original angle with respect to the direction orthogonal to the arrangement direction of the input port 11a and the output ports 11b. Accordingly, the primary reflected light L3 is moved with respect to the direction orthogonal to the input port 11a and the output ports 11b and coupled to the desired output port 11b.

Thus, when the primary reflected light L3 is diverted from the output port 11b, the control unit 18 changes the inclination angle of the mirror 16a so that the primary reflected light L3 is directed to the secondary reflected light L5 with respect to the direction orthogonal to the arrangement direction of the input port 11a and the output ports 11b. Therefore, at the time of port switching, it is possible to suppress coupling of the secondary reflected light L5 to the output port 11b.

In the above-described embodiment, an embodiment of the wavelength selective switch has been described. The wavelength selective switch 1A described above may be changed arbitrarily.

For example, in the second embodiment described above, Expressions (2A) and (4A) above have been shown as the conditions to be satisfied by the respective values of wavelength selective switch 1A. On the other hand, when the wavelength selective switch 1A does not include the anamorphic optical system 13, the respective values may satisfy Expression (1A) below in place of Expression (2A) above:

LA<f×tan(2×(θ_{2A}+α_{2A})) (1A)

and may satisfy Expression (3A) below in place of Expression (4A) above:

LA<f×tan φ_{A} (3A)

Further, as illustrated in FIG. 7, a removal portion which removes the cover reflected light L4 directed to a side of the main surface 10a of the base 10 may be provided on the main surface 10a of the base 10. For example, this removal portion may be configured by performing rough surface processing or optical absorption processing on the main surface 10a of the base 10 or the like in positions P1 and P2 hit by the cover reflected light L4. If the removal portion is provided in this way, it is possible to prevent the cover reflected light L4 from being reflected in the positions P1 and P2 and being stray light.

Further, as illustrated in FIG. 7 or 8, a fiber for transmitting monitoring-light may be provided in the position P1 hit by the cover reflected light L4. In this case, it is possible to monitor the light output with high precision using the cover reflected light arriving at a certain position without depending on the inclination angle of the deflecting face. Further, it is possible to prevent the secondary reflected light L5 from being coupled to the fiber for transmitting monitoring-light since the secondary reflected light L5 is diverted to a side opposite to the cover reflected light L4.

Further, when the reflection angle of the cover reflected light L4 from the cover 16b is great, an optical path changing mirror 20 is arranged in the position P2 so that the cover reflected light L4 is guided to the fiber for transmitting monitoring-light provided in the position P1 as described above.

Further, in the wavelength selective switch 1A, the mirror 16a and the cover 16b are inclined so that the cover reflected light L4 and the secondary reflected light L5 do not hit the main surface 10a of the base 10, such that the cover reflected light L4 and the secondary reflected light L5 can be prevented from being reflected by the main surface 10a of the base 10 and then coupled to the output port 11b.

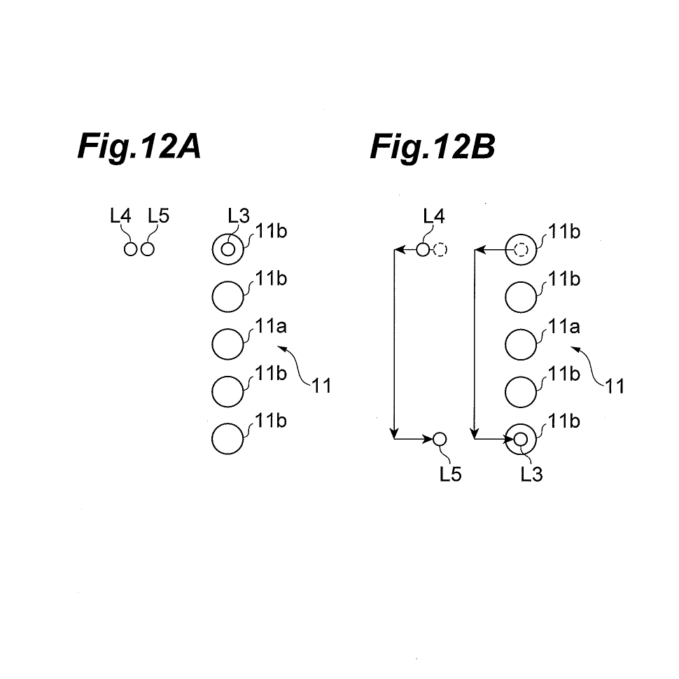

Further, in the embodiment described above, while the case in which the cover reflected light L4 and the secondary reflected light L5 are on mutually opposite sides with the input/output port array 11 interposed therebetween as illustrated in FIG. 11 has been described as an operation of the control unit 18 at the time of port switching, as illustrated in FIGS. 12A and 12B, the secondary reflected light L5 can be prevented from being coupled to the output port 11b if the inclination angle of the mirror 16a is controlled in such a manner that the primary reflected light L3 moves to a side of the secondary reflected light L5 when removing the primary reflected light L3 from the output port 11b even when the cover reflected light L4 and the secondary reflected light L5 are on the same side with respect to the input/output port array 11.

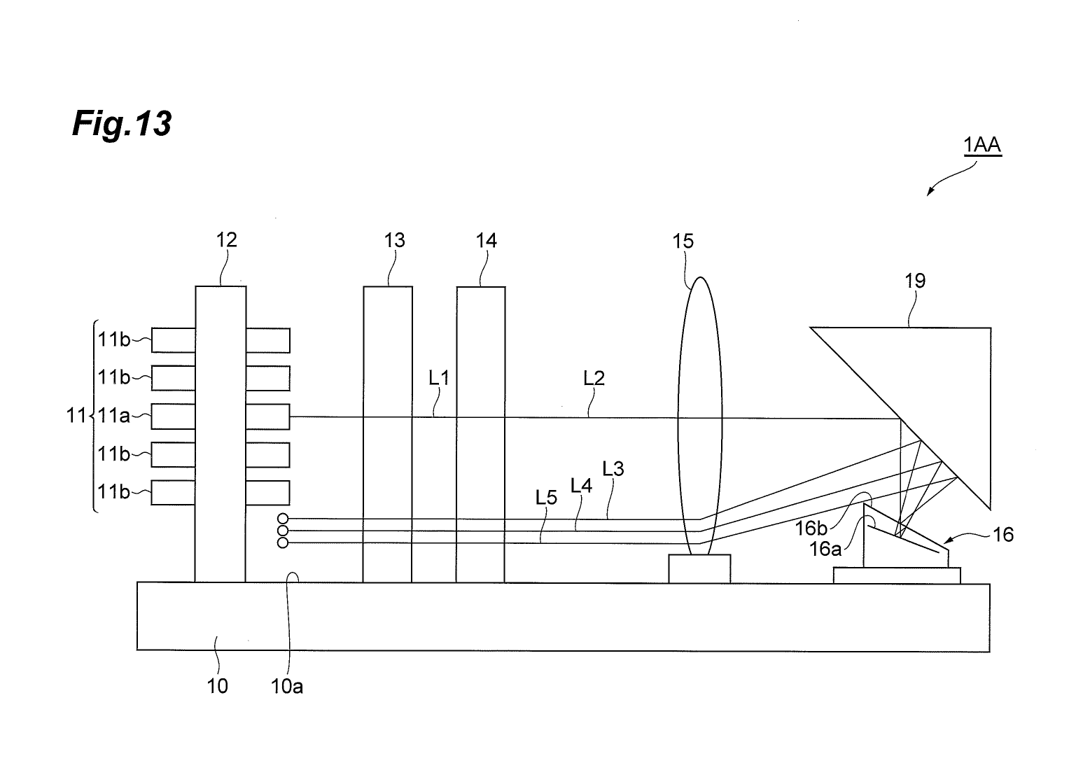

Further, for example, as illustrated in FIG. 13, the wavelength selective switch 1A may be a wavelength selective switch 1AA in which dispersed light L2 condensed by a condensing optical system 15 is changed by 90° in direction by a turning mirror 19 or the like and incident on an MEMS mirror 16.

Further, the reflection type deflecting element is not limited to the MEMS mirror 40, and may be, for example, any optical path switching element, such as an LCOS (Liquid Crystal on Silicon) or a DLP (Digital Light Processing).

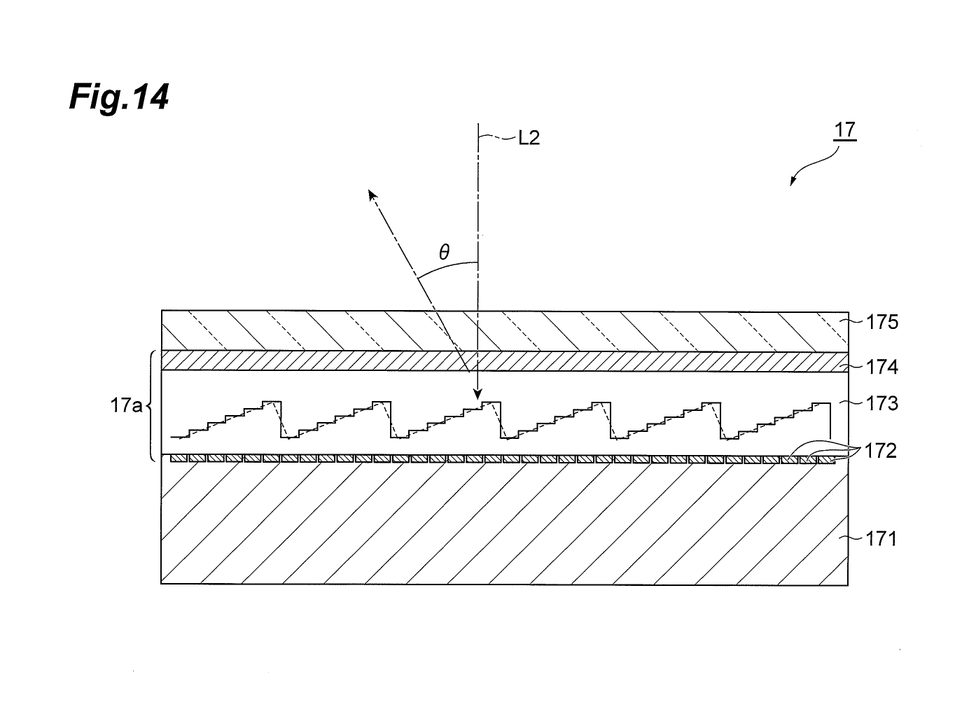

For example, a phase modulation element 17 illustrated in FIG. 14 may be adopted. FIG. 14 is a cross-sectional view illustrating an LCOS as an example of the phase modulation element. As illustrated in FIG. 14, the phase modulation element 17 includes a silicon substrate 171, and a plurality of pixel electrodes 172 provided on a main surface of the silicon substrate 171. The plurality of pixel electrodes 172 are arranged two-dimensionally along the main surface of the silicon substrate 171. Further, a liquid crystal layer 173, a transparent electrode 174 and a cover 175 are arranged sequentially on the main surface of the silicon substrate 171.

Also, a phase of each dispersed light incident on the liquid crystal layer 173 is modulated according to an intensity of an electric field formed between the transparent electrode 174 and the plurality of pixel electrodes 172. An amount of this phase modulation differs by pixel through formation of an electric field of differing intensity by pixel electrode 172. In other words, the deflecting face 17a of the reflection type deflecting element mainly includes the plurality of pixel electrodes 172, the liquid crystal layer 173 and the transparent electrode 174.

In the deflection face 17a, the phase modulation amount increases gradually from 0 (rad) to 2π (rad) and returns to 0 (rad) again after reaching 2π (rad), such that the phase modulation amount increases gradually from 0 (rad) to 2π (rad). Through such a phase modulation pattern, a phase modulation pattern of a diffraction grating shape increasing monotonically in a step shape is substantially realized. Also, when each dispersed light L2 is incident on the deflecting face 17a in which such a phase modulation pattern is presented, the dispersed light L2 is reflected at an emission angle θ according to a period of the diffraction grating.

Further, angles of the plurality of pixel electrodes 172 themselves which are reflective mirrors are not changed. In this case, the angle of the deflecting face 17a can be defined by assuming the case in which an angle of the reflective mirror itself is changed to realize the emission angle θ without performing the phase modulation, based on the emission angle θ of the emission light (the primary reflected light L3) with respect to the light incident on the LCOS. In FIG. 14, the phase modulation pattern which reflects each dispersed light L2 incident on the LCOS at an emission angle θ is shown, and when the deflecting face 17a is replaced with a reflective mirror, it may be said to be a reflective mirror with a slope of θ/2. In other words, the angle of the deflecting face 17a does not necessarily indicate an inclination angle of the reflective mirror itself and may be defined based on an emission angle θ of emission light (the primary reflected light L3) with respect to the incident light in the deflecting face.

For the above-described embodiment, the following is added.

### (Clause 1)

A wavelength selective switch includes:

an input/output port array in which an input port and an output port are arranged in a first direction;

a dispersive element which receives wavelength-multiplexed light from the input port, disperse the wavelength-multiplexed light in a second direction orthogonal to the first direction for each predetermined wavelength component, and emits dispersed light;

a condensing optical system which condenses the dispersed light emitted from the dispersive element; and

a reflection type deflecting element which receives the dispersed light condensed by the condensing optical system and deflects the dispersed light toward the output port,

wherein the reflection type deflecting element includes a deflecting face which receives the dispersed light condensed by the condensing optical system and deflects the dispersed light to the output port, and a cover which covers the deflecting face, and

the cover is inclined with respect to the second direction so that the cover reflected light which is condensed by the condensing optical system and reflected by the cover, and the secondary reflected light which is reflected by the cover, reflected by the deflecting face again and emitted from the reflection type deflecting element are diverted from the output port with respect to the second direction.

### (Clause 2)

The wavelength selective switch according to Clause 1, wherein the inclination angle θ_{2A} of the cover with respect to the second direction, the focal length f of the condensing optical system, the inclination angle α_{2A} to the second direction of the dispersed light to be incident on the reflection type deflecting element, and the distance LA from the output port for reducing intensity of light to be coupled to the output port by 40 dB satisfy Expression (1A) below:

LA<f×tan(2×(θ_{2A}+α_{2A})) (1A)

### (Clause 3)

The wavelength selective switch according to Clause 2, includes a beam expansion optical system which receives the wavelength-multiplexed light from the input port, expands the beam diameter, and causes the light to be incident on the dispersive element,

wherein, when the enlargement magnification of the beam expansion optical system is r, the inclination angle θ_{2A}, the focal length f, the inclination angle α_{2A} and the distance LA satisfy Expression (2A) below:

LA<(1/r)×f×tan(2×(θ_{2A}+α_{2A})) (2A)

### (Clause 4)

The wavelength selective switch according to any one of Clauses 1 to 3, wherein the focal length f of the condensing optical system, the distance LA from the output port for reducing intensity of light to be coupled to the output port by 40 dB, and the emission angle φ_{A} of the secondary reflected light satisfy Expression (3A) below:

LA<f×tan φ_{A} (3A)

### (Clause 5)

The wavelength selective switch according to Clause 4, includes a beam expansion optical system which receives the wavelength-multiplexed light from the input port, expands the beam diameter, and causes the light to be incident on the dispersive element,

wherein, when the enlargement magnification of the beam expansion optical system is r, the focal length f, the distance LA and the emission angle φ_{A} satisfy Expression (4A) below:

LA<(1/r)×f×tan φ_{A} (4A).

### (Clause 6)

The wavelength selective switch according to any one of Clauses 1 to 5, wherein the deflecting face is inclined in the first direction when the reflection type deflecting element is in a non-operating state, and

the inclination angle θ_{3A} of the deflecting face with respect to the first direction when the reflection type deflecting element is in the non-operating state, the focal length f of the condensing optical system, the inclination angle α_{3A} to the first direction of the dispersed light to be incident on the reflection type deflecting element, and the distance DA from the input port to the output port farthest from the input port satisfy Expression (5A) below:

DA<f×tan(2×(θ_{3A}+α_{3A})) (5A)

### (Clause 7)

The wavelength selective switch according to any one of Clauses 1 to 6, wherein the input port is arranged in a center of the input/output port array with respect to the first direction.

### (Clause 8)

The wavelength selective switch according to any one of Clauses 1 to 7, wherein a fiber for transmitting monitoring-light is provided in a position hit by the cover reflected light.

### (Clause 9)

The wavelength selective switch according to any one of Clauses 1 to 8, wherein the inclination angle θ_{1A} of the deflecting face with respect to the second direction, the inclination angle θ_{2A} of the cover with respect to the second direction and the inclination angle α_{2A} to the second direction of the dispersed light incident on the deflecting face satisfy Expression (6A) below:

θ_{2A}>2×θ_{1A}+α_{2A} (6A)

### (Clause 10)

The wavelength selective switch according to any one of Clauses 1 to 9, includes a base having a main surface orthogonal in the first direction,

wherein the input/output port array, the dispersive element and the condensing optical system are mounted on the main surface, and

the deflecting face and the cover are inclined so that the cover reflected light and the second reflected light do not hit the main surface.

### (Clause 11)

The wavelength selective switch according to any one of Clauses 1 to 10, includes a control unit for controlling the reflection type deflecting element, and

Wherein, at the time of port switching, the control unit diverts the primary reflected light that is a reflected light from the deflecting face from the predetermined output port to a side of the secondary reflected light in the second direction by changing the inclination angle of the deflecting face with respect to the second direction, moves the first reflected light to a position corresponding to the other predetermined output port along the first direction by changing the inclination angle of the deflecting face with respect to the first direction, and then moves the first reflected light in the second direction by changing the inclination angle of the deflecting face with respect to the second direction to couple the first reflected light to the other predetermined output port.

In the wavelength selective switch in accordance with Clause 1, the reflection type deflecting element includes the cover which covers the deflecting face, in addition to the deflecting face which reflects the dispersed light from the dispersive element to the output port. Also, the cover of the reflection type deflecting element is inclined with respect to the second direction so that the cover reflected light which is reflected light from the cover and the secondary reflected light which is reflected by the cover, reflected by the deflecting face again and then emitted are diverted from the output port with respect to the dispersive direction (the second direction) of the dispersive element. Thus, it is possible to suppress coupling of the cover reflected light and the secondary reflected light to the output port.

According to the wavelength selective switch in accordance with Clause 2, it is possible to reliably suppress coupling of the cover reflected light to the output port by sufficiently diverting the cover reflected light from the output port with respect to the second direction. According to the wavelength selective switch in accordance with Clause 3, it is possible to effectively perform dispersion in the dispersive element by expanding, in the second direction, the beam diameter of the wavelength-multiplexed light in a beam expansion optical system. Further, the amount of shift of the cover reflected light with respect to the output port is reduced in accordance with the enlargement magnification of the beam expansion optical system, but it is possible to sufficiently divert the cover reflected light from the output port and reliably suppress the coupling of the cover reflected light to the output port, by the respective values satisfying Expression (2A) above.

According to the wavelength selective switch in accordance with Clause 4, it is possible to reliably suppress coupling of the secondary reflected light to the output port by sufficiently diverting the secondary reflected light from the output port with respect to the second direction. According to the wavelength selective switch in accordance with Clause 5, it is possible to effectively perform dispersion in the dispersive element by expanding, in the second direction, the beam diameter of the wavelength-multiplexed light by the beam expansion optical system. Further, the amount of shift of the secondary reflected light with respect to the output port is reduced in accordance with an amount of the beam expansion optical system, but it is possible to sufficiently divert the secondary reflected light from the output port and reliably suppress coupling of the secondary reflected light to the output port by the respective values satisfying Expression (4A) above.

According to the wavelength selective switch in accordance with Clause 6, it is possible to prevent the primary reflected light from being coupled to the output port when the reflection type deflecting element is in the non-operating state. According to the wavelength selective switch in accordance with Clause 7, it is possible to simplify an optical design and relatively reduce loss.

According to the wavelength selective switch in accordance with Clause 8, it is possible to monitor the light output with high precision using the cover reflected light arriving at a certain position without depending on the inclination angle of the deflecting face. According to the wavelength selective switch in accordance with Clause 9, it is possible to cause the cover reflected light and the secondary reflected light to be directed to mutually opposing sides with respect to the dispersed light incident on the reflection type deflecting element (to the input/output ports) with respect to the second direction. Therefore, for example, when monitoring of the light output is performed using the cover reflected light, the secondary reflected light can be prevented from being coupled to the fiber for transmitting monitoring-light. Accordingly, it is possible to perform monitoring with higher precision.

According to the wavelength selective switch in accordance with Clause 10, it is possible to prevent the cover reflected light and the secondary reflected light from being reflected by the main surface of the base and then being coupled to the input/output port. In the wavelength selective switch in accordance with Clause 11, when the control unit performs port switching, the control unit first changes the inclination angle of the deflecting face to divert the primary reflected light from a predetermined output port to which the primary reflected light has been coupled. In this case, the control unit changes the inclination angle of the deflecting face so that the primary reflected light is directed to the secondary reflected light with respect to the second direction. Therefore, when the primary reflected light is diverted from the output port, the secondary reflected light becomes further away from the output port with respect to the second direction. Thus, according to the wavelength selective switch in accordance with Clause 11, it is possible to suppress coupling of the secondary reflected light to the output port at the time of port switching.

What is claimed is:

1. A wavelength selective switch comprising:
an input/output port array in which an input port and an output port are arranged in a first direction;
a dispersive element which receives wavelength-multiplexed light from the input port, disperse the wavelength-multiplexed light in a second direction orthogonal to the first direction for each predetermined wavelength component, and emits dispersed light;
a condensing optical system which condenses the dispersed light emitted from the dispersive element; and
a reflection type deflecting element which receives the dispersed light condensed by the condensing optical system and deflects the dispersed light toward the output port,
wherein the reflection type deflecting element includes a deflecting face which receives the dispersed light condensed by the condensing optical system and deflects the dispersed light to the output port, and a cover which covers the deflecting face,
the deflecting face is inclined with respect to the first direction when the reflection type deflecting element is in a non-operating state, and
an inclination angle θ₁ of the deflecting face with respect to the first direction when the reflection type deflecting element is in the non-operating state,
an inclination angle θ₂ of the cover with respect to the first direction, and
an inclination angle α to the first direction of the dispersed light incident on the deflecting face, satisfy Expression (1) below:
θ₂>2×θ₁+α (1)

2. The wavelength selective switch according to claim 1, wherein the inclination angle of the deflecting face with respect to the first direction when the reflection type deflecting element is in an operating state is smaller than the inclination angle θ₁.

3. The wavelength selective switch according to claim 1, wherein
the inclination angle θ₁,
a focal length f of the condensing optical system,
a distance L from the input port to the output port most apart from the input port, and
the inclination angle α satisfy Equation (2) below:
L<f×tan(2×(θ₁+α)) (2)

4. The wavelength selective switch according to claim 1, wherein
the inclination angle θ₂,
a focal length f of the condensing optical system,
a distance L from the input port to the output port most apart from the input port, and
the inclination angle α satisfy Equation (3) below:
L<f×tan(2×(θ₂+α)) (3)

5. The wavelength selective switch according to claim 1, wherein
a focal length f of the condensing optical system,
a distance L from the input port to the output port most apart from the input port, and
an emission angle φ of secondary reflected light which is reflected by the cover, reflected by the deflecting face again and then emitted from the reflection type deflecting element, satisfy Expression (4) below:
L<f×tan φ (4)

6. The wavelength selective switch according to claim 1, further comprising a base having a main surface orthogonal to the first direction,
wherein the input/output port array, the dispersive element and the condensing optical system are mounted on the main surface, and
the cover is inclined with respect to the first direction so that cover reflected light which is condensed by the condensing optical system and then reflected by the cover, is directed to the main surface.

7. The wavelength selective switch according to claim 6, wherein a position hit by the cover reflected light on the main surface is subjected to rough surface processing or optical absorption processing.

8. The wavelength selective switch according to claim 6, wherein a fiber for transmitting a monitoring-light is provided in a position hit by the cover reflected light on the main surface.

9. The wavelength selective switch according to claim 1, wherein the input port is arranged in a center of the input/output port array with respect to the first direction.
